(19) United States
(12) Patent Application Publication
(10) Pub. No.: US 2011/0042018 A1
(43) Pub. Date: Feb. 24, 2011

(54) BLIND ADAPTED FOR USE IN DOUBLE GLAZING

(76) Inventor: Renzhe Jin, Beijing (CN)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 12/854,618

(22) Filed: Aug. 11, 2010

(30) Foreign Application Priority Data
Aug. 19, 2009 (CN) 200910168572

(51) Int. Cl. E06B 9/28

(52) U.S. Cl. 160/178.1 R

(57) ABSTRACT

The present invention discloses a blind adapted to be used in a double glazing. The double glazing includes a magnet disposed in a lower supporting member of the double glazing. The blind comprises a weight bottom member, and magnetic members are disposed in the weight bottom member of the blind. During turning of the weight bottom member, the magnetic member disposed at a descending side of the weight bottom member is attracted by the magnet. Therefore, the turning control of the slats is more reliable. The present invention improves shadiness, shading coefficient, and heat preservation of the double glazing with the blind. The total energy saving performance of the double glazing with the blind is improved.

BACKGROUND

1. Field of the Invention

The present invention relates to a blind, and more particularly to a blind for using within a double glazing.

2. Description of the Related Art

For demands of environmental protection, energy saving and comfortable living, sunshade products are broadly used. A blind (curtain) and a foldable curtain are commonly used on indoor windows. With more than one hundred year's development, the double glazing has been widely used throughout the world, due to its special characteristics such as thermal insulating property, sound proof property, frost proof property, and dust and pollution proof property. Chinese Patents ZL03238471.8 (patent family in US is U.S. Pat. No. 7,124,803B2), ZL200320128533.5, ZL200420057384.2 and so on applied by the same applicant as the present invention relate to the blind built within the double glazing, which belongs to one of built-in sunshade products for the double glazing.

FIGS. 1A and 1B are structural schematic views of the utility model patent ZL200420057384.2, entitled “blind in double glazing” and filed by the present inventor with the SIPO on Dec. 15, 2004. As shown in FIGS. 1A and 1B, a double glazing with a blind is composed of supporting members 24, 25, an outdoor-side glass 23, an indoor-side glass 23A, and a plurality of slats 21. As shown in FIGS. 1A and 1B, the double glazing with the blind further includes elevating ropes 10, 12, ladder ropes 3, 5, a weight bottom member 20, an elevating mechanism, a slat turning mechanism and the like. The configuration facilitates operations of the blind such as elevation, opening and closing, and the operation principle will be omitted herein for purpose of brevity.

Although the slat turning mechanism can perform slat turning control, closure of the upper slats is good and closure of the slats gradually becomes worse toward a bottom of the blind since the ladder ropes are non-rigid and the weight bottom member 20 has a great weight.

As shown in FIG. 1C, in consideration of shadiness, a distance between the weight bottom member 20 and the lower supporting member 25 of the double glazing is short, and generally equal to about half of a width of the weight bottom member 20 so as to ensure that the weight bottom member 20 completely shields a bottom of a window after the weight bottom member 20 turns. Since the weight bottom member 20 does not sufficiently turn, the double glazing with the blind is degraded in shadiness, shading coefficient, and heat preservation.

Therefore, there is a need to further improve the shadiness and energy saving performance of the double glazing with the blind.

### SUMMARY

Accordingly, an object of the present invention is to provide a blind adapted to be used in a double glazing capable of effectively performing slat turning control.

In order to achieve the object, the present invention provides the following three solutions.

Solution 1

A blind adapted to be used in a double glazing including a magnet disposed in a lower supporting member of the double glazing comprises a magnetic member disposed in a weight bottom member of the blind. During turning of the weight bottom member, the magnetic member disposed at a descending side of the weight bottom member is attracted by the magnet.

According to an aspect of the present invention, the magnetic member comprises two magnetic members, the two magnetic members are juxtaposed in parallel with each other, and located at two long sides of the weight bottom member adjacent to glasses of the double glazing respectively; and the magnet comprises a plurality of magnets.

Solution 2

A blind adapted to be used in a double glazing including a magnetic member disposed in a lower supporting member of the double glazing comprises a magnet disposed in a weight bottom member of the blind. During turning of the weight bottom member, the magnet disposed at a descending side of the weight bottom member attracts the magnetic member.

According to an aspect of the present invention, the magnet comprises two magnets, the two magnets are juxtaposed in parallel with each other, and located at two long sides of the weight bottom member adjacent to glasses of the double glazing respectively; and the magnetic member comprises a plurality of magnetic members.

Solution 3

A blind adapted to be used in a double glazing including a magnet disposed in a lower supporting member of the double glazing comprises a magnet disposed in a weight bottom member of the blind. During turning of the weight bottom member, the magnet disposed at a descending side of the weight bottom member is attracted by the magnet disposed in the lower supporting member of the double glazing.

According to an aspect of the present invention, the magnet disposed in the weight bottom member of the blind comprises two magnets, the two magnets are juxtaposed in parallel with each other, and located at two long sides of the weight bottom member adjacent to glasses of the double glazing respectively; and the magnet disposed in the lower supporting member of the double glazing comprises a plurality of magnets.

The present invention can improve shadiness and heat preservation of the double glazing with the blind by providing a supplementary force for pulling the weight bottom member to excellently close the blind in the double glazing for shading.

### BRIEF DESCRIPTION OF THE DRAWINGS

FIGS. 1A and 1B are structural schematic views showing a conventional double glazing with a blind;

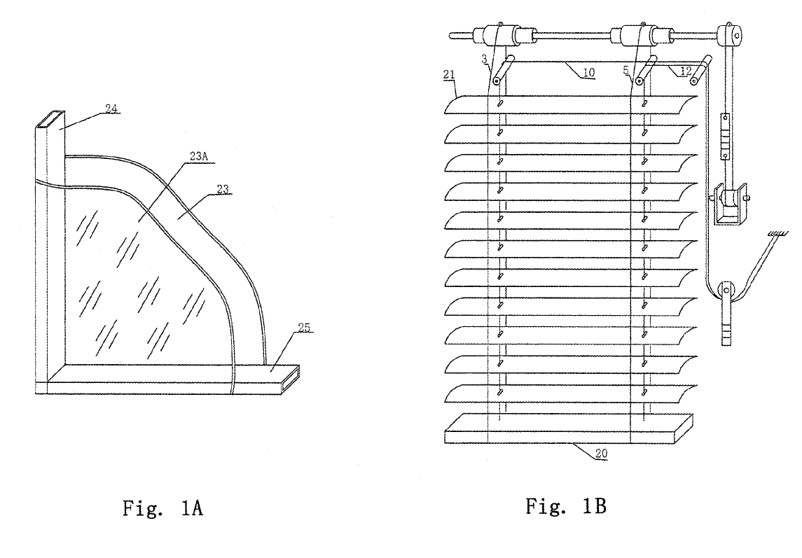

FIG. 1C is a side view of the conventional double glazing, in which the conventional blind is in a closed state and slats of the blind are not completely closed;

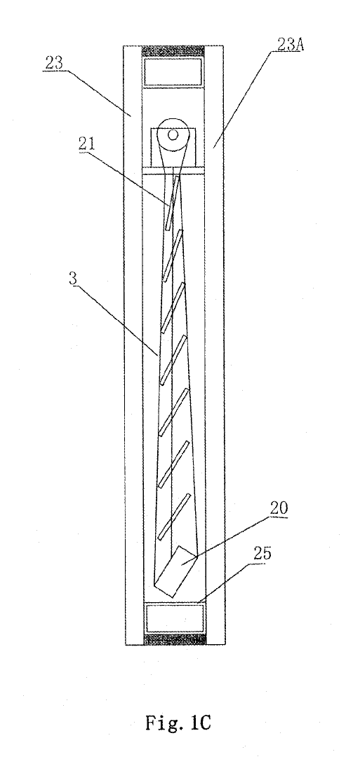

FIGS. 2A and 2B are schematic views showing a double glazing with a blind according to an embodiment of the present invention; and

FIG. 2C is a side view of the double glazing according to the embodiment of the present invention, in which the blind is in a closed state and slats of the blind are completely closed.

### DETAILED DESCRIPTION

Embodiments of the present invention will be described hereinafter in detail with reference to the drawings, wherein the like reference numerals refer to the like elements throughout the specification. The present invention may, however, be embodied in many different forms and should not be construed as being limited to the embodiments set forth herein; rather, these embodiments are provided so that the present disclosure will be thorough and complete, and will fully convey the concept of the invention to those skilled in the art.

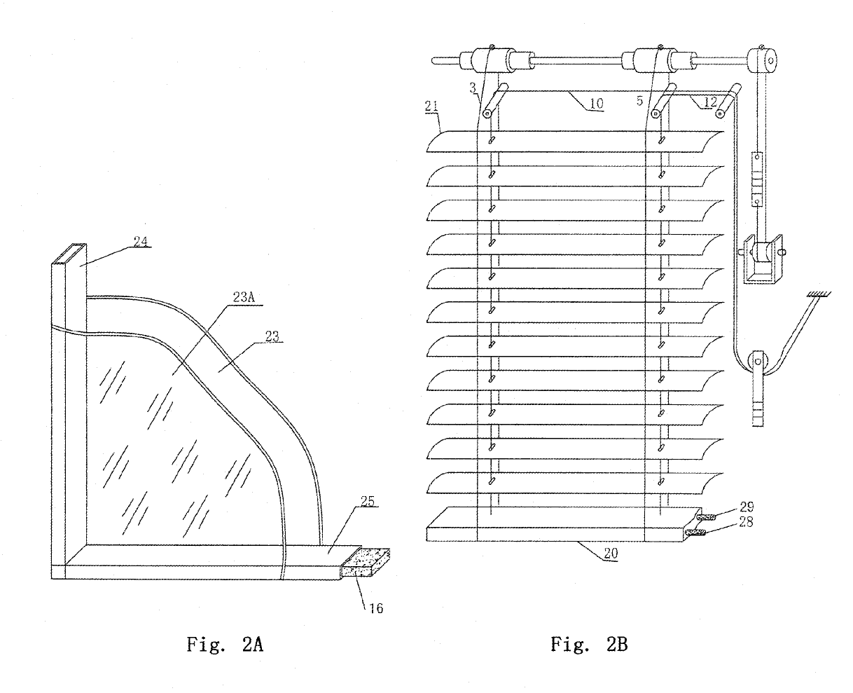

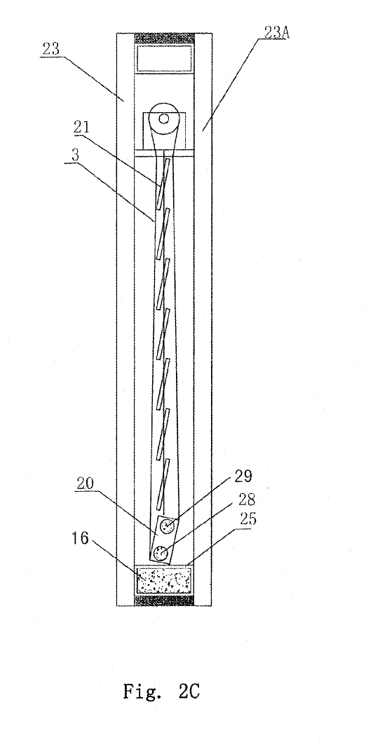

FIGS. 2A and 2B are schematic views showing a double glazing with a blind according to an embodiment of the present invention and FIG. 2C is a side view of the double glazing according to the embodiment of the present invention, in which the blind is in a closed state and slats 21 of the blind are completely closed.

Referring to FIGS. 2A and 2B, two iron wires 28 and 29 are disposed inside a weight bottom member 20 of the blind, and located at two long sides of the weight bottom member 20 adjacent to glasses 23 and 23A of the double glazing, respectively. A plurality of magnets 16 are disposed inside a lower supporting member 25 of the double glazing. Only one magnet of the plurality of magnets is illustrated in the figure. Two magnets may be disposed at both ends of the lower supporting member 25 respectively, or three magnets may be disposed at a left portion, an intermediate portion and a right portion of the lower supporting member 25, respectively.

When a user operates a slat turning mechanism of the blind, the weight bottom member 20 turns with the slat turning mechanism, and for example, one side of the weight bottom member where the iron wire 28 is disposed descends. The iron wire 28 on the one side descends to gradually approach the lower supporting member 25 of the double glazing, while the iron wire 29 on the other side ascends to gradually depart away from the he lower supporting member 25 of the double glazing. Since the distance between the weight bottom member 20 and the lower supporting member 25 of the double glazing is short, during descending of the iron wire 28, the iron wire 28 is easily attracted by an attracting force of the magnets 16 disposed inside the lower supporting member 25 of the double glazing. The attracting force generates a force pulling the iron wire 28 downward to facilitate the turning of the weight bottom member 20. Referring to FIG. 2C, under the action of the attracting force of the magnets 16, the weight bottom member 20 can be effectively turned completely to drive the entire blind to close completely.

It would be appreciated by those skilled in the art that many modifications, alterations and substitutions may be made in these embodiments without departing from the principles and spirit of the invention, the scope of which is defined in the claims and their equivalents.

For example, the iron wires 28 and 29 disposed inside the weight bottom member 20 may be replaced with a magnet, and accordingly the magnets 16 disposed inside the lower supporting member 25 of the double glazing may be replaced with an iron member.

Alternatively, the iron wires 28 and 29 disposed inside the weight bottom member 20 may be replaced with a magnet and the magnets 16 are still disposed inside the lower supporting member 25 of the double glazing. A polarity of the magnet disposed inside the weight bottom member 20 and polarities of the magnets disposed inside the lower supporting member 25 of the double glazing are configured to form attraction when the slat turning mechanism turns the slats.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A blind adapted to be used in a double glazing including a magnet disposed in a lower supporting member of the double glazing, the blind comprising:
a weight bottom member, a magnetic member being disposed in the weight bottom member of the blind,
wherein during turning of the weight bottom member, the magnetic member disposed at a descending side of the weight bottom member is attracted by the magnet.

2. The blind adapted to be used in a double glazing according to claim 1, wherein
the magnetic member comprises two magnetic members, the two magnetic members are juxtaposed in parallel with each other, and located at two long sides of the weight bottom member adjacent to glasses of the double glazing respectively; and
the magnet comprises a plurality of magnets.

3. A blind adapted to be used in a double glazing including a magnetic member disposed in a lower supporting member of the double glazing, the blind comprising:
a weight bottom member, a magnet being disposed in the weight bottom member of the blind,
wherein during turning of the weight bottom member, the magnet disposed at a descending side of the weight bottom member attracts the magnetic member.

4. The blind adapted to be used in a double glazing according to claim 3, wherein
the magnet comprises two magnets, the two magnets are juxtaposed in parallel with each other, and located at two long sides of the weight bottom member adjacent to glasses of the double glazing respectively; and
the magnetic member comprises a plurality of magnetic members.

5. A blind adapted to be used in a double glazing including a magnet disposed in a lower supporting member of the double glazing, the blind comprising:
a weight bottom member, a magnet being disposed in the weight bottom member of the blind,
wherein during turning of the weight bottom member, the magnet disposed at a descending side of the weight bottom member is attracted by the magnet disposed in the lower supporting member of the double glazing.

6. The blind adapted to use in a double glazing according to claim 5, wherein
the magnet disposed in the weight bottom member of the blind comprises two magnets, the two magnets are juxtaposed in parallel with each other, and located at two long sides of the weight bottom member adjacent to glasses of the double glazing respectively; and
the magnet disposed in the lower supporting member of the double glazing comprises a plurality of magnets.
